(19) United States
(12) Patent Application Publication
(10) Pub. No.: US 2018/0345059 A1
(43) Pub. Date: Dec. 6, 2018

(54) FIRESTOP SYSTEM FOR MARINE OR OFF-SHORE APPLICATIONS

(71) Applicant: 3M INNOVATIVE PROPERTIES COMPANY, St. Paul, MN (US)

(72) Inventors: John C. Hulteen, Afton, MN (US); Richard J. Haffner, New Richmond, WI (US); Ernst L. Schmidt, Hager City, WI (US)

(73) Assignee: 3M INNOVATIVE PROPERTIES COMPANY, St. Paul, MN (US)

(21) Appl. No.: 15/777,819

(22) PCT Filed: Nov. 14, 2016
(86) PCT No.: PCT/US2016/061743

§ 371 Date: May 21, 2018

Related U.S. Application Data
(60) Provisional application No. 62/259,803, filed on Nov. 25, 2015.

(51) Int. Cl. A62C 3/10; A62C 2/06

(52) U.S. Cl. CPC A62C 3/10; A62C 5/02; A62C 2/065

(57) ABSTRACT

Described herein is a firestop system for marine or off-shore applications comprising a foam layer comprising at least one fire-stopping additive and a non-porous structural sealant layer.

### TECHNICAL FIELD

A firestop system for marine and off-shore applications is described comprising a foam layer and a non-porous structural sealant layer.

### SUMMARY

There is a desire to identify alternative firestop materials for treating penetrations in marine and off-shore applications, which may allow advantages in ease of use, decreased time, and/or aesthetics.

In one embodiment, use of a 2-component firestop system for marine applications is described comprising a fire-stopping foam layer; and a non-porous structural sealant layer.

In another embodiment, a method of fire-stopping and sealing a substrate is described, the method comprising

providing a marine construction assembly comprising (i) a major surface, wherein the surface comprises a penetration which intersects the major surface, the major surface further comprising a first attachment area located about the perimeter of the penetration, and (ii) a penetrating object having a second attachment area, wherein the penetrating object passes through the penetration and extends beyond the major surface of the marine construction assembly;

inserting a foam layer comprising at least one fire-stopping additive into the penetration,

sealing the penetration by applying a non-porous structural sealant to the major surface contacting the first attachment area and the second attachment area; and

curing the non-porous structural sealant.

In yet another embodiment, a marine article is disclosed wherein the marine article comprises a through penetration and the through penetration is treated with a foam layer comprising a fire-stopping additive and a non-porous structural sealant layer.

The above summary is not intended to describe each embodiment. The details of one or more embodiments of the invention are also set forth in the description below. Other features, objects, and advantages will be apparent from the description and from the claims.

### BRIEF DESCRIPTION OF THE DRAWINGS

FIG. 1 is a side-view of one side of an embodiment of the present disclosure; and

FIG. 2 is a side-view of one side of another embodiment of the present disclosure.

### DETAILED DESCRIPTION

As used herein, the terms

“marine construction assembly” refers to a construction such as a bulkhead or a deck used in marine and off-shore constructions comprising at least one major surface;

“penetration” refers to an opening (or hole) which intersects the major surface of the marine construction assembly to enable the passage of at least one penetrating object through the marine construction assembly;

“penetrating object” refers to a physical item that passes through the penetration and extends beyond the surface of the marine construction assembly. Such penetrating objects include cables, conduits, ducts, pipes, etc.;

“a”, “an”, and “the” are used interchangeably and mean one or more; and “and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The present disclosure is directed toward the treatment of openings within marine and offshore constructions. Surprisingly, it has been discovered that packing the penetration with a foam comprising a fire-stopping additive and sealing the penetration with a non-porous structural sealant (also referred to herein interchangeably with structural sealant), can provide a system that can act as a firestop and mitigate water intrusion, and optionally, withstand pressure exposure.

As used herein, a firestop is a material intended to close off an opening or penetration during a fire.

Marine and offshore constructions include constructions that are periodically or permanently submerged in water, more specifically large bodies of water, and even more specifically, seas. Such constructions may include, vessels (such as boats, barges, or ships) or structures (such as bridges, tunnels, or oil rigs).

Openings in the bulkheads, decks, etc. of the constructions can occur to allow for through penetrations of communication cables, power cables, service pipes, and ducts. Once an opening is made into the construction, integrity performance of the construction needs to be reinstated. The 2-component systems disclosed herein can be used to restore the integrity performance of the construction for marine and off-shore applications. For example, marine and offshore constructions can have a required fire rating based on the construction materials and building code requirements. The 2-component systems disclosed herein can be used as a firestop to prevent the compromising of the penetration in instances of a fire and prevent the spread of fire, while at the same time, mitigating water intrusion and optionally withstanding pressure exposure during the construction's routine use.

The constructions of the present disclosure comprise an opening (or penetration) along a major surface of the marine construction assembly.

These penetrations can occur at various locations and numbers along the marine construction assembly. The shape (circular, oblong, rectangular, etc.) and width of the opening can vary. In one embodiment, the length of the smallest dimension of the opening is at least 0.125, 0.25, 0.5, 0.75, 0.825, 1, 2, 3, 4, or even 5 inch (3.1, 6.4, 12.7, 19, 21, 25, 51, 76, 102, or even 127 mm); and at most 16, 48, or even 60 inches (406, 1219, or even 1524 mm). Typically, in the larger opening dimensions, a penetrating object is present and will consume a portion of the opening. Therefore, the amount of the penetration requiring sealing with the foam will be a portion of the dimension of the penetration. For example, a surface comprising a 2 inch diameter circular opening with a 1.5 inch diameter pipe therethrough would require sealing of the opening around the perimeter of the pipe (about 0.25 inches around the outside of the pipe).

The penetrations of the present disclosure comprise a penetrating object therethrough. These penetrating objects are used to transmit power, communication signals, gas, heat, water, etc. from one part of the construction to another. In one embodiment, the penetrating object is a cable or other electrical pathway, or a pipe.

The penetrating objects can be made from a variety of materials commonly used in the marine and off-shore industry including, for example, metal, glass, fiberglass, and plastic (including polyethylene, polypropylene, polyvinyl chloride, and fluorinated plastics such as polytetrafluoroethylene (PTFE)).

In the present disclosure, a foam and a non-porous structural sealant are used to create a firestop system for marine and off-shore applications.

In the present disclosure, the foam is used as a firestop material, preventing the spread of fire, and/or heat, and optionally decreasing the flow of gases between the hot (or fire-side) and cold side of the marine construction assembly.

The foam of the present disclosure contains at least one fire-stopping additive. Typical fire-stopping additives are: endothermic, char forming and ablative, insulative, flame retardant, and/or intumescent in nature.

An endothermic compound is one that absorbs heat typically by releasing water of hydration. Endothermic compounds include magnesium ammonium phosphate, magnesium hydroxide hydrate, and calcium sulfate hydrate (also known as gypsum). Preferred endothermic compounds are essentially insoluble in water and include alumina trihydrate and hydrated zinc borate, for example. In one embodiment, the amount of endothermic compound used is at least 5, 10 or even 15%; and no more than 30, 40, or even 50% by weight relative to the weight of the foam.

“Char” is a carbonaceous residue formed upon heating a char forming material to a temperature of greater than about 250° C., as would be experienced when exposed to flames. The char formed is often resistant to erosion due to the heat and pressures encountered during a fire. Useful char forming resins include epoxy resins, phenolic resins, polycarboimide resins, urea-formaldehyde resins, and melamine-formaldehyde resins. The general term “phenolic” refers to phenol-formaldehyde resins as well as resins comprising other phenol-derived compounds and formaldehydes. In one embodiment, the amount of char forming compound used is at least 1, 2 or even 5%; and no more than 10, 15, or even 20% by weight relative to the weight of the foam.

Insulative additives can be inorganic fibrous materials that may be comprised of fiberglass, mineral wool, refractory ceramic materials, and mixtures thereof. These additives work by creating an insulative thermal barrier between the fire and the “cold side” of the construction. In one embodiment, the amount of insulative compound used is at least 5, 10 or even 15%; and no more than 30, 40, or even 50% by weight relative to the weight of the foam.

Exemplary flame retardants additives include phosphorous-containing compounds (e.g., ethylene diamine phosphate, magnesium ammonium phosphate, polymer-encapsulated ammonium polyphosphate, and organic phosphate oils), boron-containing compounds, alumina trihydrate, antimony oxide, and other metal oxides and hydrates. Exemplary flame retardant materials also include glass frit, as disclosed for example, in U.S. Pat. No. 4,879,066 (Crompton). Various mixtures and combinations of these materials may be used. Preferred flame retardants include ethylene diamine phosphate. Flame retardants are typically used in an amount sufficient to impart flame retardancy to the fire barrier material. In one embodiment, the amount of flame retardant additive used is at least 1, 2 or even 5%; and no more than 10, or even 15% by weight relative to the weight of the foam.

An intumescent compound is one that expands to at least about 1.5 times its original volume upon heating to a temperature greater than its intumescence activation temperature. Typical intumescent compounds include, but are not limited to, intercalated graphite, hydrated alkali metal silicates, unexpanded vermiculite, perlite, mica, organic intumescent compounds such as melamine (i.e., 2, 4, 6-triamino-1, 3, 5-triazine), azocarbonamide, and benzene sulfonyl hydrazide which decompose to give off gases, and mixtures thereof. The intumescent compound is present at least in an amount sufficient to prevent the foam from shrinking when it is heated and may be used in an amount to produce expansion up to about 5 times, in some instances up to nine times, and even up to 30 times, the original volume of fire barrier material when it is exposed to a fire. The amount of intumescent material in the formulation varies depending on the type of intumescent chosen. In one embodiment, the amount of intumescent compound used is at least 1, 2 or even 5%; and no more than 10, 15, or even 20% by weight relative to the weight of the foam.

Exemplary foams of the present disclosure comprising the fire-stopping additive can include: polyurethane, silicone, and combinations thereof. The cell structure of these foams may be open or closed cell. In one embodiment, open cell is preferred. Open cell foams have voids that generally intersect one another, forming paths that percolate through the material. These foams tend to be soft and compressible compared to closed cell foams. Closed cell foams have discrete voids in a polymeric matrix.

In one embodiment, the foam of the present disclosure is a self-curing composition that exhibits a controlled expansion as it cures. One such type of foam is a polyurethane foam. The controlled expansion is obtained by taking advantage of the normal susceptibility for the isocyanate groups of the polyisocyanate precursor in the composition to react with any water present to form carbon dioxide that then acts to foam the polyurethane as it is formed. The compositions undergo a foaming that is controlled both as to time of occurrence—the principal expansion occurring after the mixture has reached a highly viscous stage and as to amount the total expansion being between about 5 and 25 percent. Since the foaming does not occur until the composition has cured to a viscous stage, the composition does not flow freely in the penetration under the force of the pressure caused by the generated carbon dioxide, but instead a great deal of radial pressure develops which forces the liquid composition between the opening and the penetrating object.

In one embodiment, the polyurethane foam, which includes the fire-stopping additive, may also include, but is not limited to, an isocyanate, a polyol, a blowing agent, a catalyst, and surfactants. An isocyanate may comprise any isocyanate-functional molecules and/or mixtures thereof, along with any other suitable components.

Polyisocyanates, e.g. diisocyanates, triisocyanates, and isocyanates of still higher functionality, may be used. Some number of monofunctional isocyanates may be used if desired for particular purposes. Any such isocyanates may be aliphatic or aromatic, or mixtures thereof. Suitable isocyanates include, but are not limited to, methylene bis 4,4′ cyclohexylisocyanate, cyclohexyl diisocyanate, isophorone diisocyanate, hexamethylene diisocyanate, propylene-1,2-diisocyanate, tetramethylene-1,4-diisocyanate, 1,6-hexamethylene-diisocyanate, dodecane-1,12-diisocyanate, cyclobutane-1,3-diisocyanate, cyclohexane-1,3-diisocyanate, cyclohexane-1,4-diisocyanate, 1-isocyanato-3,3,5-trimethyl-5-isocyanatomethylcyclohexane, methyl cyclohexylene diisocyanate, triisocyanate of hexamethylene diisocyanate, triisocyanate of 2,4,4-trimethyl-1,6-hexane diisocyanate, uretdione of hexamethylene diisocyanate, ethylene diisocyanate, 2,2,4-trimethylhexamethylene diisocyanate, 2,4,4-trimethylhexamethylene diisocyanate, dicyclohexylmethane diisocyanate and the like. In some embodiments, the isocyanate mixture includes methylene diphenylene diisocyanate (commonly referred to as MDI), which may be primarily diphenylmethane 4,4′-diisocyanate but may also include other isomers, dimers, oligomers, and/or higher homologues thereof. In particular embodiments, the isocyanate mixture may be comprised predominately of the material known as polymeric MDI, which is known by those of skill in the art to comprise a mixture of MDI isomers and higher homologues, for example, polymeric MDI often comprises approximately 50 wt. % MDI, approximately 30 wt. % tri-isocyanate homologue, approximately 10 wt. % tetra-isocyanate homologue, approximately 5 wt. % penta-isocyanate homologue, and approximately 5 wt. % higher homologues. In some embodiments, the isocyanate mixture is substantially free of toluene diisocyanate (TDI), and isomers and oligomers thereof. In specific embodiments, the only isocyanates in the isocyanate mixture are MDI and/or oligomers and/or prepolymers etc. thereof.

Polyols may comprise any suitable polyol and/or mixtures thereof. The hydrocarbon chain of the polyols can have saturated or unsaturated bonds and substituted or unsubstituted aromatic and cyclic groups. Polyether polyols may be preferred in some cases for the enhanced flexibility that they may provide. Suitable polyether polyols may include, but are not limited to, polytetramethylene ether glycol (“PTMEG”), polyethylene propylene glycol, polyoxypropylene glycol, and mixtures thereof. Suitable polyester polyols include, but are not limited to, polyethylene adipate glycol, polybutylene adipate glycol, polyethylene propylene adipate glycol, o-phthalate-1,6-hexanediol, poly(hexamethylene adipate) glycol, and mixtures thereof. Polyols based on, or derived from, glycerol and the like (e.g., produced by condensing multiple glycerol molecules together to form polyethers) may be used if desired. Suitable polyols may range from e.g. diols, triols, to tetraols, or even higher. Suitable polyols may thus include, but are not limited to, ethylene glycol, diethylene glycol, polyethylene glycol, propylene glycol, polypropylene glycol, lower molecular weight polytetramethylene ether glycol, 1,3-bis(2-hydroxyethoxy)benzene, 1,3-bis-[2-(2-hydroxyethoxy)ethoxy]benzene, 1,3-bis-{2-[2-(2-hydroxyethoxy)ethoxy]ethoxy}benzene, 1,4-butanediol, 1,5-pentanediol, 1,6-hexanediol, resorcinol-di-(beta-hydroxyethyl)ether, hydroquinone-di-(beta-hydroxyethyl)ether, and mixtures thereof. Any of these may be blended e.g. with any of the above-discussed polyols, and may serve, as may any other suitably reactive materials, as chain extenders and the like. The polyol mixture may include any other suitable compounds that comprise active hydrogen atoms (that can react with N═C═O groups), as desired.

One or more surfactants may be employed in the foam-forming composition. The surfactants lower the bulk surface tension, promote nucleation of bubbles, stabilize the rising cellular structure, emulsify incompatible ingredients, and may have some effect on the hydrophilicity of the resulting foam. The surfactants typically used in polyurethane foam applications are polysiloxane-polyoxyalkylene copolymers, which are generally used at levels between about 0.5 and 3 parts by weight per 100 parts polyol. Surfactants, which may for example be organic or silicone based, such as FOMREZ M66-86A (Chemtura), L532 (GE Silicones) B8301 (Evonik) and 9100 (Altana), may be used to stabilize the cell structure, to act as emulsifiers and to assist in mixing.

Catalysts are used to control the relative rates of water-polyisocyanate (gas-forming or blowing) and polyol-polyisocyanate (gelling) reactions. The catalyst may be a single component, or in most cases a mixture of two or more compounds. Preferred catalysts for polyurethane foam production are organotin salts and tertiary amines. The amine catalysts are known to have a greater effect on the water-polyisocyanate reaction, whereas the organotin catalysts are known to have a greater effect on the polyol-polyisocyanate reaction. Total catalyst levels generally vary from 0 to 5.0 parts by weight per 100 parts polyol. The amount of catalyst used depends upon the formulation employed and the type of catalyst, as known to those skilled in the art.

Suitable urethane catalysts useful in the present invention are all those well known in the art, including tertiary amines such as triethylenediamine, N-methylimidazole, 1,2-dimethylimidazole, N-methylmorpholine, N-ethylmorpholine, triethylamine, tributylamine, triethanolamine, dimethylethanolamine and bisdimethylaminodiethylether, and organotins such as stannous octoate, stannous acetate, stannous oleate, stannous laurate, dibutyltin dilaurate, and others such as tin salts.

In one embodiment, the foam is a silicone foam. Silicones are synthetic polymers based on chains or networks of alternating silicon and oxygen atoms. Also called polymerized siloxanes or polysiloxanes, silicones have the general chemical formula [R2SiO]n, where R is an organic group such as methyl, ethyl, or phenyl. Chemically, these materials have an inorganic silicon-oxygen backbone ( . . . —Si—O—Si—O—Si—O— . . . ) with organic side groups attached to the silicon atoms. Silicones are generally known for their uses as electrical insulators, waterproofing agents, rubbers and resins.

Various methods can be used to prepare foamed silicone polymers. Some involve use of a physical or chemical blowing agent. Physical blowing agents are generally volatile liquids that can be used to create voids in a matrix, thereby producing a cellular (or foamed) material. Common physical blowing agents include chlorofluorocarbons, hydrochlorofluorocarbons, hydrocarbons and liquid carbon dioxide. Chemical blowing agents expand the foam using one or more chemical reactions that produce a gas. An exemplary chemical blowing agent is powdered titanium hydride, which can be used to make metallic foams by decomposing into titanium and hydrogen gas at elevated temperatures.

A blowing agent may be included in the foam composition. The most typical blowing agent is water that may be added in amounts from 1.5 to 5.0 parts per 100 parts polyol. Alternative blowing agents are liquid carbon dioxide, volatile organic compounds, such as pentane and acetone, and chlorinated compounds, such as methylene chloride, HFC's, HCFC's and CFC's.

Optional additives may be included in the foam but are not limited to fillers, pigments, and dyes.

Fillers may be included to add reinforcement, adjust the stiffness, alter the handleability, or produce other desirable characteristics of the firestop either before or after exposure to heat and flame. Exemplary fillers include fumed silica, clay, fly ash, perlite, vermiculite, glass powders or frits, sodium aluminates, zinc borate, boric oxide, inorganic fibers (e.g., glass fibers, glass ceramic fibers, ceramic fibers, mineral fibers, and carbon fibers), and organic fibers (e.g., thermoplastic fibers such as nylon fibers and polyester fibers). Some of these refractory materials (i.e., oxides, borates, and glass and ceramic materials) may contribute to the fire retardancy of the firestop material. If a halogenated organic polymeric material is used as a binder, zinc oxide is typically added to scavenge HCl, which may be given off when the fire stop material is heated. While glass frit has been described above as a useful flame retardant, it may also be used as a filler.

Pigments and dyes may be useful as an identification aid for the product, indicating manufacturer or indicating sufficient curing of the product. Exemplary pigments include iron oxides, titanium dioxide (e.g., rutile), carbon black, and synthetic organic pigments. Exemplary dyes include FD&C Blue #1.

In one embodiment, the foam is pre-formed (or an insert), which is placed into the penetration. The insert may have resilient properties which permit the foam to be pressure fit in the opening and around the penetrating object.

In another embodiment, the foam is a 2-part composition which is applied directly into the penetration. This is advantageous because the foam can form around the opening and penetration object, filling crevices. Preferably, this type of foam expands and increases in viscosity quickly such that a supporting dam in not necessary.

Ideally, the foam spans the entire cross-section of the opening and forms a surface upon which the structural sealant can be applied. However, the foam need not necessarily form a seal (i.e., prevent fluid passage).

The depth of packing (i.e., the distance the foam fills beginning from the outer surface and extending into the construction) for the foam can depend on the desired rating of the construction and the thermal resistance of the foam as is known in the art.

In one embodiment, the foam layer has a depth (or thickness) of at least 2 in (5 cm), 4 in (10 cm), 6 in (15 cm), 8 in (20 cm), or even 10 in (25 cm). However, more or less depth can be used based on the application and desired rating of the construction.

A structural sealant layer is disposed over the foam and seals the opening. In one embodiment, the structural sealant layer contacts the foam layer.

The structural sealant useful in the present disclosure include those that are non-porous, structural in nature, and sufficiently adheres to the surfaces of interest (for example, metal (e.g., aluminum or steel), concrete, and plastics).

The structural sealant of the present disclosure is non-porous to the passage of water. It is believed that the non-porosity of the structural sealant is important for sealing of the penetration, preventing fluid passage, such as water, air, and/or gas.

The structural sealant of the present disclosure is structural, meaning that it has a tensile strength of greater than 100, 500, 1000, 2000, or even 5000 psi tensile. The tensile strength may be measured via ASTM D2370-98 (2010) “Standard Test Method for Tensile Properties of Organic Coatings”, ASTM D412-06A (2013) “Standard Test Methods for Vulcanized Rubber and Thermoplastic Elastomers-Tension”, ASTM D882-12 “Standard Test Method for Tensile Properties of Thin Plastic Sheeting”, and Fed. Std. No. 406, Method 1011.

The structural sealant of the present disclosure must comprise sufficient adhesion to the marine construction assembly. This can be tested by applying the structural sealant to the same material as the marine construction assembly and/or penetrating object and testing per ASTM D 4541-09 “Standard Test Method for Pull Off Strength of Coatings Using Portable Adhesion Testers” or ASTM D1002-2010 “Standard Test Method for Apparent Shear Strength of Single-Lap-Joint Adhesively Bonded metal Specimens by Tension Loading (Metal-to-Metal). In one embodiment, the structural sealant of the present disclosure has an overlap shear strength of at least 250 psi (1.7 MPa), 500 psi (3.4 MPa), 1000 psi (6.9 MPa), 1500 psi (10.3 MPa), or even 2000 psi (13.8 MPa) as per ASTM D1002-2010.

Preferably, the structural sealant of the present disclosure is not water soluble, wherein a water soluble structural sealant will soften and reduce tensile in the presence of water, resulting in the passage of water.

In one embodiment, the structural sealant of the present disclosure may be in the form of a first part (e.g., curable resin) and a second part (e.g., curing agent). Additional parts, which further separate the components of the structural sealant may be used if desired. The components in each part are typically selected such that little or no reactivity occurs within that part.

When ready for application, the various parts of the structural sealant are mixed together. This can be done using manual, static or dynamic methodologies. These parts are typically mixed together immediately prior to use of the structural sealant. The amount of each part included in the mixture can be selected to provide, e.g., the desired molar ratio of curable end group to the curating agent. The particular components are also selected so that the structural sealant is coatable (for example, it does not completely cure and/or form a gel prior to application onto the construction).

The structural sealant can be applied to the construction by a variety of means including, for example use of a 2-part mixture, which mixed and applied to the construction (or applied and then mixed on the construction); or 1-part composition that is applied to the construction (typically cured via ambient moisture, heat or light).

Any suitable application method can be used to apply the mixture to the marine construction assembly. Suitable application methods include, for example, brushing, rolling, spraying, and the like. In one embodiment, the structural sealant is a coating, which can be applied using coating techniques known in the art.

In one embodiment, the structural sealant mixture is applied directly onto the foam. For example, a final mixed composition of the structural sealant can be applied using a brush, roller, or other manual application method, or by spraying onto the marine construction assembly comprising the foam treated penetration using an applicable delivery method.

After coating, the coatable structural sealant then may be subsequently cured chemically, or via heat or electromagnetic radiation.

In one embodiment, the curable structural sealant is cured chemically by the reaction of a curable resin with a curing agent. For example in epoxy systems, a curable epoxy resin can be reacted with primary or secondary amines. In silicone systems, a curable silicone resin can be reacted to water (moisture) to cure the resin forming the structural sealant.

In one embodiment, the structural sealant can be cured (i.e., polymerized and/or crosslinked) at room temperature, can be cured at room temperature and then at an elevated temperature (e.g., greater than 100° C., greater than 120° C., or greater than 150° C.), or can be cured at an elevated temperature. In some embodiments, the curable coating composition can be cured at room temperature for at least 2 hours, or at least 4 hours. In other embodiments, the curable coating composition can be cured at room temperature for any suitable length of time and then further cured at an elevated temperature such as, for example, 180° C. for a time up to 10 minutes, up to 20 minutes, up to 30 minutes, up to 60 minutes, up to 120 minutes, or even longer than 120 minutes.

In one embodiment, the curable structural sealant is exposed to electromagnetic radiation such as ultraviolet radiation (e.g., 300-400 nm) to cure the structural sealant.

Exemplary structural sealants include: an epoxy, a phenolic, acrylates, an imide, silicones, urethane, and hybrids thereof.

In one embodiment, the structural sealant is an epoxy that comprises a first part comprising a curable epoxy resin and a second part comprising a curing agent. In one embodiment, the curable epoxy resin contains at least one epoxy functional group (i.e., oxirane group) per molecule.

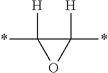 [SMILES: *C1OC1*]

If the oxirane group is at the terminal position of the epoxy resin, the oxirane group is typically bonded to a hydrogen atom.

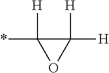 [SMILES: *C1CO1]

This terminal oxirane group is often part of a glycidyl group.

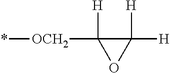

The curable epoxy resin has at least one oxirane group per molecule and often has at least two oxirane groups per molecule. For example, the curable epoxy resin can have 1 to 10, 2 to 10, 1 to 6, 2 to 6, 1 to 4, or 2 to 4 oxirane groups per molecule. The oxirane groups are usually part of a glycidyl group.

The curable epoxy resins can be contained in one part or can be divided among 2 or more parts to provide the desired viscosity characteristics before curing and to provide the desired mechanical properties after curing. If the curable epoxy resin is divided among 2 or more parts, at least one of the parts is usually selected to comprise a curable epoxy resin having at least two oxirane groups per molecule. For example, a first curable epoxy resin in the mixture can have two to four or more oxirane groups and a second curable epoxy resin in the mixture can have one to four oxirane groups. In some of these examples, the first curable epoxy resin is a first glycidyl ether with two to four glycidyl groups and the second curable epoxy resin is a second glycidyl ether with one to four glycidyl groups.

The portion of the curable epoxy resin molecule that is not an oxirane group (i.e., the epoxy resin molecule minus the oxirane groups) can be aromatic, aliphatic or a combination thereof and can be linear, branched, cyclic, or a combination thereof. The aromatic and aliphatic portions of the epoxy resin can include heteroatoms or other groups that are not reactive with the oxirane groups. That is, the curable epoxy resin can include halo groups, oxy groups such as in an ether linkage group, thio groups such as in a thio ether linkage group, carbonyl groups, carbonyloxy groups, carbonylimino groups, phosphono groups, sulfono groups, nitro groups, nitrile groups, and the like. The curable epoxy resin can also be a silicone-based material such as a polydiorganosiloxane-based material.

Although the curable epoxy resin can have any suitable molecular weight, the weight average molecular weight is usually at least 100 grams/mole, at least 150 grams/mole, at least 175 grams/mole, at least 200 grams/mole, at least 250 grams/mole, or at least 300 grams/mole. The weight average molecular weight can be up to 50,000 grams/mole or even higher for polymeric epoxy resins. The weight average molecular weight is often up to 40,000 grams/mole, up to 20,000 grams/mole, up to 10,000 grams/mole, up to 5,000 grams/mole, up to 3,000 grams/mole, or up to 1,000 grams/mole. For example, the weight average molecular weight can be in the range of 100 to 50,000 grams/mole, in the range of 100 to 20,000 grams/mole, in the range of 10 to 10,000 grams/mole, in the range of 100 to 5,000 grams/mole, in the range of 200 to 5,000 grams/mole, in the range of 100 to 2,000 grams/mole, in the range of 200 to 2,000 gram/mole, in the range of 100 to 1,000 grams/mole, or in the range of 200 to 1,000 grams/mole.

Suitable curable epoxy resins are liquid at room temperature (“RT”, as used herein, this refers to a temperature of 20° C. to 30° C. or preferably 20° C. to 25° C.).

In most embodiments, the curable epoxy resin comprises a glycidyl ether. Exemplary glycidyl ethers can be of Formula (I)

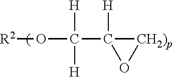

In Formula (I), group R² is a p-valent group that is aromatic, aliphatic, or a combination thereof. Group R² can be linear, branched, cyclic, or a combination thereof. Group R² can optionally include halo groups, oxy groups, thio groups, carbonyl groups, carbonyloxy groups, carbonylimino groups, phosphono groups, sulfono groups, nitro groups, nitrile groups, and the like. Although the variable p can be any suitable integer greater than or equal to 1, p is often an integer in the range of 2 to 10, in the range of 2 to 6, or in the range of 2 to 4.

In some exemplary glycidyl ethers of Formula (I), the variable p is equal to 2 (i.e., the epoxy resin is a diglycidyl ether) and R² includes an alkylene (i.e., an alkylene is a divalent radical of an alkane and can be referred to as an alkane-diyl), heteroalkylene (i.e., a heteroalkylene is a divalent radical of a heteroalkane and can be referred to as a heteroalkane-diyl), arylene (i.e., a divalent radical of a arene compound), or combination thereof. Suitable alkylene groups often have 1 to 20 carbon atoms, 1 to 12 carbon atoms, 1 to 8 carbon atoms, or 1 to 4 carbon atoms. Suitable heteroalkylene groups often have 2 to 50 carbon atoms, 2 to 40 carbon atoms, 2 to 30 carbon atoms, 2 to 20 carbon atoms, 2 to 10 carbon atoms, or 2 to 6 carbon atoms with 1 to 10 heteroatoms, 1 to 6 heteroatoms, or 1 to 4 heteroatoms. The heteroatoms in the heteroalkylene can be selected from oxy, thio, or —NH— groups but are often oxy groups. Suitable arylene groups often have 6 to 18 carbon atoms or 6 to 12 carbon atoms. For example, the arylene can be phenylene or biphenylene. Group R² can further optionally include halo groups, oxy groups, thio groups, carbonyl groups, carbonyloxy groups, carbonylimino groups, phosphono groups, sulfono groups, nitro groups, nitrile groups, and the like. The variable p is usually an integer in the range of 2 to 4.

Some glycidyl ethers of Formula (I) are diglycidyl ethers where R² includes (a) an arylene group or (b) an arylene group in combination with an alkylene, heteroalkylene, or both. Group R² can further include optional groups such as halo groups, oxy groups, thio groups, carbonyl groups, carbonyloxy groups, carbonylimino groups, phosphono groups, sulfono groups, nitro groups, nitrile groups, and the like. These epoxy resins can be prepared, for example, by reacting an aromatic compound having at least two hydroxyl groups with an excess of epichlorohydrin. Examples of useful aromatic compounds having at least two hydroxyl groups include, but are not limited to, resorcinol, catechol, hydroquinone, p,p′-dihydroxydibenzyl, p,p′-dihydroxyphenylsulfone, p,p′-dihydroxybenzophenone, 2,2′-dihydroxyphenyl sulfone, and p,p′-dihydroxybenzophenone. Still other examples include the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenyle thylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Some commercially available diglycidyl ether epoxy resins of Formula (I) are derived from bisphenol A (i.e., bisphenol A is 4,4′-dihydroxydiphenylmethane). Examples include, but are not limited to, those available under the trade designations EPON (e.g., EPON 828, EPON 872, and EPON 1001) from Momentive Specialty Chemicals, Inc., Columbus, Ohio, DER (e.g., DER 331, DER 332, and DER 336) from Dow Chemical Co., Midland, Mich., and EPICLON (e.g., EPICLON 850) from Dainippon Ink and Chemicals, Inc., Chiba, Japan. Other commercially available diglycidyl ether epoxy resins are derived from bisphenol F (i.e., bisphenol F is 2,2′-dihydroxydiphenylmethane). Examples include, but are not limited to, those available under the trade designations DER (e.g., DER 334) from Dow Chemical Co., and EPICLON (e.g., EPICLON 830) from Dainippon Ink and Chemicals, Inc.

Other glycidyl ethers of Formula (I) are diglycidyl ethers of a poly(alkylene oxide) diol. These curable epoxy resins also can be referred to as diglycidyl ethers of a poly(alkylene glycol) diol. The variable p is equal to 2 and R² is a heteroalkylene having oxygen heteroatoms. The poly(alkylene glycol) portion can be a copolymer or homopolymer and often includes alkylene units having 1 to 4 carbon atoms. Examples include, but are not limited to, diglycidyl ethers of poly(ethylene oxide) diol, diglycidyl ethers of poly(propylene oxide) diol, and diglycidyl ethers of poly(tetramethylene oxide) diol. Epoxy resins of this type are commercially available from Polysciences, Inc., Warrington, Pa., such as those derived from a poly(ethylene oxide) diol or from a poly(propylene oxide) diol having a weight average molecular weight of about 400 grams/mole, about 600 grams/mole, or about 1000 gram/mole.

Still other glycidyl ethers of Formula (I) are diglycidyl ethers of an alkane diol (R² is an alkylene and the variable p is equal to 2). Examples include a diglycidyl ether of 1,4-dimethanol cyclohexyl, diglycidyl ether of 1,4-butanediol, and a diglycidyl ether of the cycloaliphatic diol formed from a hydrogenated bisphenol A such as those commercially available under the trade designations EPONEX (e.g., EPONEX 1510) from Momentive Specialty Chemicals, Inc., Columbus, Ohio, and EPALLOY (e.g., EPALLLOY 5001) from CVC Thermoset Specialties, Moorestown, N.J.

For some applications, the curable epoxy resins chosen for use in the structural sealant are novolac epoxy resins, which are glycidyl ethers of phenolic novolac resins. These resins can be prepared, for example, by reaction of phenols with an excess of formaldehyde in the presence of an acidic catalyst to produce the phenolic novolac resin. Novolac epoxy resins are then prepared by reacting the phenolic novolac resin with epichlorohydrin in the presence of sodium hydroxide. The resulting novolac epoxy resins typically have more than two oxirane groups and can be used to produce structural sealants with a high crosslinking density. The use of novolac epoxy resins can be particularly desirable in applications where corrosion resistance, water resistance, chemical resistance, or a combination thereof is desired. One such novolac epoxy resin is poly[(phenyl glycidyl ether)-co-formaldehyde]. Other suitable novolac resins are commercially available under the trade designations ARALDITE (e.g., ARALDITE GY289, ARALDITE EPN 1183, ARALDITE EP 1179, ARALDITE EPN 1139, and ARALDITE EPN 1138) from Huntsman Corp., Salt Lake City, Utah, EPALLOY (e.g., EPALLOY 8230) from CVC Thermoset Specialties, Moorestown, N.J., and DEN (e.g., DEN 424 and DEN 431) from Dow Chemical, Midland, Mich.

Yet other curable epoxy resins include silicone resins with at least two glycidyl groups and flame retardant epoxy resins with at least two glycidyl groups (e.g., a brominated bisphenol-type epoxy resin having with at least two glycidyl groups such as that commercially available from Dow Chemical Co., Midland, Mich., under the trade designation DER 580).

The curable epoxy resin is often a mixture of materials. For example, the curable epoxy resins can be selected to be a mixture that provides the desired viscosity or flow characteristics prior to curing. The mixture can include at least one first epoxy resin that is referred to as a reactive diluent that has a lower viscosity and at least one second epoxy resin that has a higher viscosity. The reactive diluent tends to lower the viscosity of the epoxy resin composition and often has either a branched backbone that is saturated or a cyclic backbone that is saturated or unsaturated. Examples include, but are not limited to, the diglycidyl ether of resorcinol, the diglycidyl ether of cyclohexane dimethanol, the diglycidyl ether of neopentyl glycol, and the triglycidyl ether of trimethylolpropane. Diglycidyl ethers of cyclohexane dimethanol are commercially available under the trade designations HELOXY MODIFIER (e.g., HELOXY MODIFIER 107) from Momentive Specialty Chemicals, Columbus, Ohio, and EPODIL (e.g., EPODIL 757) from Air Products and Chemical Inc., Allentown, Pa. Other reactive diluents have only one functional group (i.e., oxirane group) such as various monoglycidyl ethers. Some example monoglycidyl ethers include, but are not limited to, alkyl glycidyl ethers with an alkyl group having 1 to 20 carbon atoms, 1 to 12 carbon atoms, 1 to 8 carbon atoms, or 1 to 4 carbon atoms. Some monoglycidyl ethers that are commercially available include those under the trade designation EPODIL from Air Products and Chemical, Inc., Allentown, Pa., such as EPODIL 746 (2-ethylhexyl glycidyl ether), EPODIL 747 (aliphatic glycidyl ether), and EPODIL 748 (aliphatic glycidyl ether).

The curable epoxy resin is cured by reacting with a curing agent that is typically in a second part. Stated differently, the curable epoxy resin is typically separated from the curing agent during storage or prior to use. In one embodiment, the curing agent has at least two primary amino groups, at least two secondary amino groups, or combinations thereof. That is, the curing agent has at least two groups of formula —NR¹H where R¹ is selected from hydrogen, alkyl, aryl, or alkylaryl. Suitable alkyl groups often have 1 to 12 carbon atoms, 1 to 8 carbon atoms, 1 to 6 carbon atoms, or 1 to 4 carbon atoms. The alkyl group can be cyclic, branched, linear, or a combination thereof. Suitable aryl groups usually have 6 to 12 carbon atom such as a phenyl or biphenyl group. Suitable alkylaryl groups can be either an alkyl substituted with an aryl or an aryl substituted with an alkyl. The same aryl and alkyl groups discussed above can be used in the alkylaryl groups.

When the first part and the second part of the structural sealant are mixed together, the primary and/or secondary amino groups of the curing agent react with the oxirane groups of the curable epoxy resin. This reaction opens the oxirane groups and covalently bonds the curing agent to the epoxy resin. The reaction results in the formation of divalent groups of formula —OCH²—CH²—NR¹— where R¹ is equal to hydrogen, alkyl, aryl, or alkylaryl.

The curing agent minus the at least two amino groups (i.e., the portion of the curing agent that is not an amino group) can be any suitable aromatic group, aliphatic group, or combination thereof. Some amine curing agents are of Formula (II) with the additional limitation that there are at least two primary amino groups, at least two secondary amino groups, or at least one primary amino group and at least one secondary amino group.

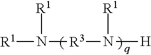

Each R¹ group is independently hydrogen, alkyl, aryl, or alkylaryl. Suitable alkyl groups for R¹ often have 1 to 12 carbon atoms, 1 to 8 carbon atoms, 1 to 6 carbon atoms, or 1 to 4 carbon atoms. The alkyl group can be cyclic, branched, linear, or a combination thereof. Suitable aryl groups for R.sup.1 often have 6 to 12 carbon atoms such as a phenyl or biphenyl group. Suitable alkylaryl groups for R.sup.1 can be either an alkyl substituted with an aryl or an aryl substituted with an alkyl. The same aryl and alkyl groups discussed above can be used in the alkylaryl groups. Each R.sup.3 is independently an alkylene, heteroalkylene, or combination thereof. Suitable alkylene groups often have 1 to 18 carbon atoms, 1 to 12 carbon atoms, 1 to 8 carbon atoms, 1 to 6 carbon atoms, or 1 to 4 carbon atoms. Suitable heteroalkylene groups have at least one oxy, thio, or —NH— group positioned between two alkylene groups. Suitable heteroalkylene groups often have 2 to 50 carbon atoms, 2 to 40 carbon atoms, 2 to 30 carbon atoms, 2 to 20 carbon atoms, or 2 to 10 carbon atoms and up to 20 heteroatoms, up to 16 heteroatoms, up to 12 heteroatoms, or up to 10 heteroatoms. The heteroatoms are often oxy groups. The variable q is an integer equal to at least one and can be up to 10 or higher, up to 5, up to 4, or up to 3.

Some amine curing agents can have an R³ group selected from an alkylene group. Examples include, but are not limited to, ethylene diamine, diethylene diamine, diethylene triamine, triethylene tetramine, propylene diamine, tetraethylene pentamine, hexaethylene heptamine, hexamethylene diamine, 2-methyl-1,5-pentamethylene diamine, 1-amino-3-aminomethyl-3,3,5-trimethylcyclohexane (also called isophorene diamine), 1,3 bis-aminomethyl cyclohexane, and the like. Other amine curing agents can have an R³ group selected from a heteroalkylene group such as a heteroalkylene having oxygen heteroatoms. For example, the curing agent can be a compound such as aminoethylpiperazine, 4,7,10-trioxatridecane-1,13-diamine (TTD) (available from TCI America, Portland, Oreg.), or a poly(alkylene oxide) diamine (also called polyether diamines) such as a poly(ethylene oxide) diamine, poly(propylene oxide) diamine, or a copolymer thereof. Commercially available polyether diamines are available under the trade designation JEFFAMINE from Huntsman Corp., Salt Lake City, Utah.

Still other amine curing agents can be formed by reacting a polyamine (i.e., a polyamine refers to an amine with at least two amino groups selected from primary amino groups and secondary amino groups) with another reactant to form an amine-containing adduct having at least two amino groups. For example, a polyamine can be reacted with an epoxy resin to form an adduct having at least two amino groups. If a polymeric diamine is reacted with a dicarboxylic acid in a molar ratio of diamine to dicarboxylic acid that is greater than or equal to 2:1, a polyamidoamine having two amino groups can be formed. In another example, if a polymeric diamine is reacted with an epoxy resin having two glycidyl groups in a molar ratio of diamine to epoxy resin greater than or equal to 2:1, an amine-containing adduct having two amino groups can be formed. Such a polyamidoamine can be prepared as described, for example, in U.S. Pat. No. 5,629,380 (Baldwin et al.). A molar excess of the polymeric diamine is often used so that the curing agent includes both the amine-containing adduct plus free (non-reacted) polymeric diamine. For example, the molar ratio of diamine to epoxy resin with two glycidyl groups can be greater than 2.5:1, greater than 3:1, greater than 3.5:1, or greater than 4:1. Even when epoxy resin is used to form the amine-containing adduct in the second part of the curable coating composition, additional epoxy resin is present in the first part of the curable coating composition.

The curing agent can also be an aromatic ring substituted with multiple amino groups or with amino-containing groups. Such curing agents include, but are not limited to, xylene diamines (e.g., meta-xylene diamine) or similar compounds. For example, such curing agents are commercially available under the trade designations ANCAMINE (e.g., ANCAMINE 2609) from Air Products, Allentown, Pa., and ARADUR (e.g., ARADUR 2965 or ARADUR 3246) from Huntsman Corp., Salt Lake City, Utah.

Various combinations of epoxy resins can be used if desired. Analogously, various combinations of curing agents can be used if desired.

The ratio of amine hydrogen equivalent weight to epoxy equivalent weight is often selected to be close to 1:1 (e.g., 1.2:1 to 1:1.2, 1.1:1 to 1:1.1, or 1.05:1 to 1:1.05). For example, for an epoxy resin that has reactive glycidyl groups, a preferred molar ratio of glycyidyl groups in the epoxy resin to amino groups in the curing agent is in a range of 1.2:1 to 1:1.2.

Suitable urethane resins include polymers made from the reaction product of a compound containing at least two isocyanate groups (—N═C═O), referred to herein as “isocyanates”, and a compound containing at least two active-hydrogen containing groups. Examples of active-hydrogen containing groups include primary alcohols, secondary alcohols, phenols, and water. A wide variety of isocyanate-terminated materials and appropriate co-reactants are well known, and many are commercially available for example, polyuerethane dispersion based PSA's from Dow Chemical Co. Also see, for example, Gunter Oertel, “Polyurethane Handbook”, Hanser Publishers, Munich (1985)).

Suitable silicone resins include moisture-cured silicones, condensation-cured silicones, and addition-cured silicones, such as hydroxyl-terminated silicones, silicone rubber, and fluoro-silicone. Examples of suitable commercially available silicone PSA compositions comprising silicone resin include Dow Corning's 280A, 282, 7355, 7358, 7502, 7657, Q2-7406, Q2-7566 and Q2-7735; General Electric's PSA 590, PSA 600, PSA 595, PSA 610, PSA 518 (medium phenyl content), PSA 6574 (high phenyl content), and PSA 529, PSA 750-D1, PSA 825-D1, and PSA 800-C. An example of a two-part silicone resin is commercially available under the trade designation “SILASTIC J” from Dow Chemical Company, Midland, Mich.

The penetrations disclosed herein occur in constructions, thus, the non-porous structural sealant of the present disclosure is fixedly attached to a surface of the marine construction assembly, wherein the surface can be made of metal (e.g., steel, aluminum), cement (e.g., Portland cement concrete), concrete, wood, fiberglass, plastics, and combinations thereof.

In one embodiment, the marine construction assembly comprises a thin wall (i.e., a wall having a thickness less than the depth of thickness of the foam). In order to provide sufficient depth for the placement of the firestop, a coaming is attached to the thin wall. For example, in one embodiment, the thin wall is about 10 mm in thickness while the coaming has a length of 10 to 20 cm, which allows for a sufficient thickness of the foam layer to function as a firestop. As is known in the ship-building art, the coaming is water-proofly joined to the thin wall around the perimeter of the opening typically via welding.

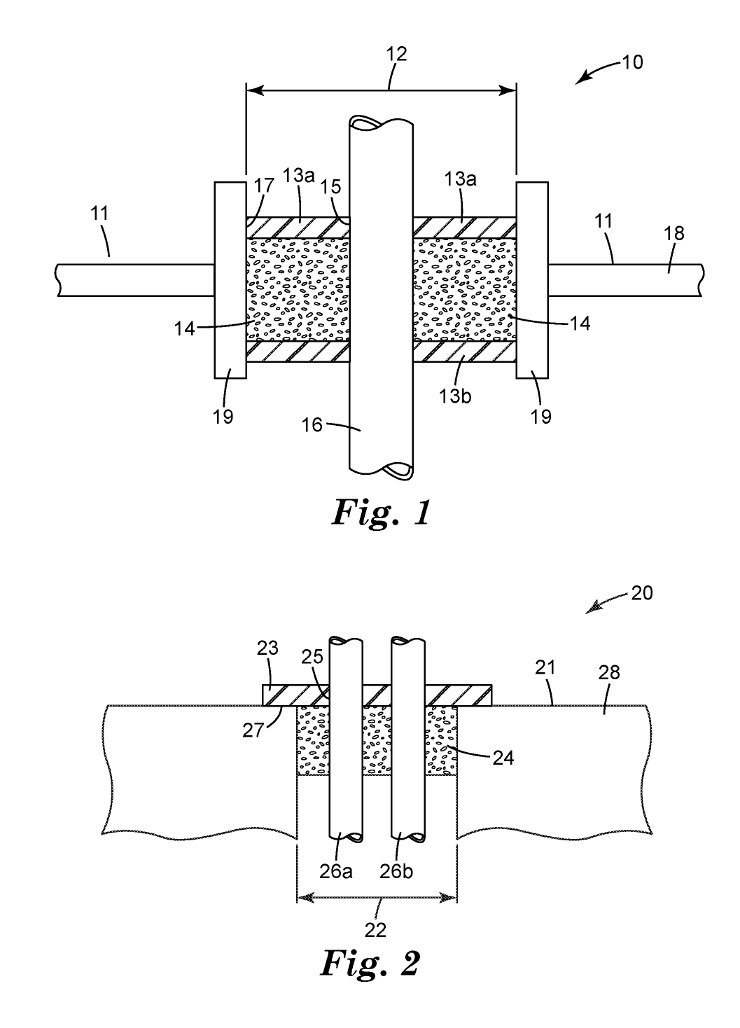

FIG. 1 (not drawn to scale) depicts a side view of an exemplary configuration of a 2-component firestop system 10 of the present disclosure comprising a thin wall with a penetration therethrough. Opening 12 intersects first major surface 11 of thin wall 18. Penetrating object 16 passes through the thin wall via opening 12. Foam 14 is placed into opening 12 around penetrating object 16. First major surface 11 comprises coaming 19 located about the perimeter of opening 12. Coaming 19 comprises first attachment area 17 around the interior of the coaming. Non-porous structural sealant layer 13a is disposed on top of foam 14. Penetrating object 16 comprises a second attachment area 15 around its perimeter near the intersection of non-porous structural sealant layer 13a. Non-porous structural sealant 13a is fixedly attached to first attachment area 17 and second attachment area 15, sealing the surface of the construction assembly.

In one embodiment, the 2-component firestop system comprises a foam layer disposed between two non-porous structural sealant layers. This fire-stop system would be advantageous on interior constructions, wherein the fire may occur on either side on the construction. FIG. 1 depicts such a construction, comprising foam 14 disposed between first non-porous structural sealant layer 13a and second non-porous structural sealant layer 13b.

Depicted in FIG. 1 is a penetration occurring along the face of a planar surface of a marine construction assembly, which encompass a majority of the penetrations in the marine and off-shore applications. However, in one embodiment, a penetration can occur at the meeting of two structural elements that may be at an angle relative to each other, such as penetration occurring at the meeting between the bulkhead and the deck.

FIG. 2 (not drawn to scale) depicts a side view of another exemplary configuration of a 2-component firestop system 20 of the present disclosure comprising a thick wall with 2 penetrations therethrough. Opening 22 intersects first major surface 21 of wall 28. First major surface 21 comprises first attachment area 27. Penetrating objects 26a and 26b pass through the opening 22. Foam 24 is placed into opening 22 around penetrating objects 26a and 26b. Non-porous structural sealant layer 23 is disposed on top of foam 24. Penetrating object 26a comprises a second attachment area 25 around its perimeter near the intersection of non-porous structural sealant layer 23. Non-porous structural sealant 23 is fixedly attached to first attachment area 27 and second attachment area 25 sealing the first major surface of the construction assembly.

The structural sealant should sufficiently cover the space between the opening and the penetrating object, to seal the opening, mitigating water intrusion. The structural sealant should sufficiently contact the marine construction assembly and the penetrating object to maintain contact and maintain a seal over the lifetime of the firestop.

In one embodiment, before the application of the structural sealant and/or foam, the surfaces to which the structural sealant will attach can be cleaned or treated to minimize attachment issues. Such techniques (wiping, washing, degreasing, sandblasting, plasma etching, etc.) are known in the art.

The basic standards for preparing metal substrates are a joint effort between the Society for Protective Coatings (SSPC) and the National Association of Corrosion Engineers International (NACE). The preferred level of cleaning would include, SSPC-SP5/NACE 1. However, as low as SSPC-SP2 may be acceptable or even as high as SP11.
a. SSPC-SP2 Hand Tool Cleaning. Removes all loose mill scale, loose rust, loose paint, and other loose detrimental foreign matter by hand chipping, scraping, sanding, and wire brushing.
b. SSPC-SP3 Power Tool Cleaning. Removes all loose mill scale, loose rust, loose paint, and other loose detrimental foreign matter by power wire brushing, power sanding, power grinding, power tool chipping, and power tool descaling.
c. SSPC-SP5/NACE 1 White Metal Blast Cleaning. When viewed without magnification, the surface shall be free of all visible oil, grease, dust, dirt, mill scale, rust, coating, oxides, corrosion products and other foreign matter.
d. SSPC-SP6/NACE 3 Commercial Blast Cleaning. When viewed without magnification, the surface shall be free of all visible oil, grease, dust, dirt, mill scale, rust, coating, oxides, corrosion products and other foreign matter of at least 66⅔% of unit area, which shall be a square 3 in.×3 in. (9 sq. in.). Light shadows, slight streaks, or minor discolorations caused by stains of rust, stains of mill scale, or stains of previously applied coating in less than 33⅓% of the unit area is acceptable.
e. SSPC-SP7/NACE 4 Brush-Off Blast Cleaning. When viewed without magnification, the surface shall be free of all visible oil, grease, dirt, dust, loose mill scale, loose rust, and loose coating. Tightly adherent mill scale, rust, and coating may remain on the surface. Mill scale, rust, and coating are considered tightly adherent if they cannot be removed by lifting with a dull putty knife.
f. SSPC-SP10/NACE 2 Near-White Blast Cleaning. When viewed without magnification shall be free of all visible oil, grease, dust, dirt, mill scale, rust, coating, oxides, corrosion products and other foreign matter of at least 95% of each unit area. Staining shall be limited to no more than 5 percent of each unit area, and may consist of light shadows, slight streaks, or minor discolorations caused by stains of rust, stains of mill scale, or stains of previously applied coatings. Unit area shall be approximately 3 in.×3 in. (9 sq. in.).

The thickness of the structural sealant layer should be thick enough to withstand the water-tightness and gas-tightness testing for a desired rating. In one embodiment, the thickness of the structural sealant layer is at least 0.12 in (3 mm), 0.25 in (6 mm), 0.5 in (12 mm), or even 1 in (25 mm). As higher pressures are required, larger thickness of structural sealant may be needed.

The structural sealant should make sufficient contact with the penetrating object and the surface of the marine construction assembly to ensure a durable, water-tight seal. In the case of a coaming as shown in FIG. 1, the surface area of the first and second attachment areas are determined by the thickness of the structural sealant layer. In the case where a coming is not used as shown in FIG. 2, the contact between the structural sealant and the marine construction assembly is determined by the amount of overlap of the structural sealant onto the marine construction assembly. In one embodiment, the amount of overlap is at least 0.25, 0.5, 0.75, 1, 2, or even 4 inches (6.4, 12.7, 19, 25.4, 50.8, or even 101.6 mm); and at most 6 or even 12 inches (152.4, or even 304.8 mm). The acceptable amount of area that the structural sealant contacts the marine construction assembly and/or the penetrating object can depend on the composition of the surface (e.g., steel versus plastic); structural sealant used; and/or cleaning or treatment of the surfaces.

The firestop system of the present disclosure comprises at a minimum a foam layer and a non-porous structural sealant layer, wherein the structural sealant layer is positioned toward the outside of the construction and the foam is positioned toward the fire-side of the construction.

In one embodiment, the firestop system of the present disclosure consists essentially of a foam layer and a non-porous structural sealant layer, meaning that the firestop system may comprise additional layers that do not contribute to the fire-stopping or water-proofing ability of the firestop system. For example, if the foam does not expand quickly and quickly increase in viscosity, a support layer may be used to hold the foam in place until it sufficiently cures into place.

In one embodiment, the firestop system of the present disclosure consists of only the foam and the non-porous structural sealant.

In the present disclosure, the structural sealant is used to prevent breaching of water from one side of the marine construction assembly to the other. In one embodiment, the non-porous structural sealant can withstand the differential movement of the penetrating object relative to the construction assembly due to, for example, expanding and contracting of the penetrating object and shifting of the penetrating object relative to the construction assembly.

In the present disclosure, the foam layer comprising the fire-stopping additive is used as a thermal barrier to protect the structural sealant from the temperatures experiences during a fire so as to maintain its integrity.

It has been discovered that filling the opening with a foam and sealing with a structural sealant, provides a firestop system for marine and off-shore applications. Heretofore, methods of providing such firestop systems include multiple layers of different material (such as three or more) that take days to install and weeks or months to be fully cured and the construction ready for use. The fire-stop system disclosed herein can be installed in less than a day, or even less than 1 hour and ready for use within 24 hours. This decrease in time can be especially important when the firestop system is being applied to the repair or maintenance of an article such as a ship.

The systems disclosed herein can be used as a fire-stop in marine and off-shore applications, meaning that they can be used to prevent high temperature and/or hot gasses from passing therethrough and can withstand the water and pressure limits experienced by marine and off-shore constructions.

To pass an approved fire test, the 2-component systems of the present disclosure (comprising the marine construction assembly, the penetration, the penetrating object, the foam, and the non-porous structural sealant) need to withstand a defined temperature profile (for example, exceeding temperatures greater than 180° C. over the initial temperature) for a period of time (e.g., 15 min., 30 min., or even 2 hours). The system is then rated based on the outcome of the tests. For example, if there are no failures at 1 hour following the test methods, the system is then rated for 1-hour. In one embodiment, the fire-resistant system of the present disclosure withstands the approved regiment of testing for a period of at least 30 minutes, at least 1 hour, or even at least 2 hours.

In one embodiment, the firestop is a fire-rated system, which passes an approved regiment of testing. Such a test include: IMO Resolution A754 “Fire Test Procedure Code MSC 88/26/Add.2 Appendix 2. In one embodiment, the fire-stop systems disclosed herein provide a fire rating for 30 minutes, 1 hour, or even 2 hours.

In fire safety marine and off-shore applications, not only is a fire-rating important, but the firestop system must also pass a water-tight test and optionally a pressure test.

As the constructions in marine and off-shore application are at least periodically exposed to water, watertight testing is done to measure the ability of the system to prevent water leakage. To pass an approved watertight test, the 2-component systems of the present disclosure (comprising the construction assembly, the penetration, the optional penetrating object, the fire-stopping foam, and the non-porous structural sealant) need to withstand a defined hydraulic test pressure (for example, hydraulic pressure equal to a minimum 1.0 bar pressure) for a period of time (as described in the standards). The system is then rated based on the outcome of the tests.

In one embodiment, the constructions used in marine and off-shore application may be exposed to greater than ambient pressures. Therefore, pressure testing is done to measure the ability of the system to withstand pneumatic pressures. To pass an approved pressure tight test, the 2-component systems of the present disclosure (comprising the construction assembly, the penetration, the optional penetrating object, the fire-stopping foam, and the non-porous structural sealant) need to withstand a defined pneumatic test pressure (for example, equal to 30 mbar) for a period of time.

In one embodiment, the fire-stop system has a pressure rating of 1.5 bar (150 kiloPascal, kPa) for 30 min or even 4.5 bar (450 kPa) for 30 min.

In one embodiment, the fire-stop system of the present disclosure when tested as described in UL 1479-2015, 4^{th} edition “Standard for Fire Tests of Penetration Firestops”, section 8.2-8.4, for at least 72 hours, shows no leakage of water as noted by the observance of water or dye.

Exemplary embodiments of the present disclosure include the following:

### Embodiment 1

Use of a 2-component firestop system for marine applications comprising: a foam layer comprising at least one fire-stopping additive; and a non-porous structural sealant layer.

### Embodiment 2

The use of embodiment 1, wherein the structural sealant has an overlap shear strength of at least 250 psi (1.7 MPa).

### Embodiment 3

The use of any one of the preceding embodiments, wherein the foam layer comprises an open cell foam.

### Embodiment 4

The use of any one of the preceding embodiments, wherein the foam layer comprises at least one of: a polyurethane, silicone, and combinations thereof.

### Embodiment 5

The use of embodiment 4, wherein the polyurethane comprises a polyisocyanate.

### Embodiment 6

The use of any one of the preceding embodiments, wherein the at least one fire-stopping additive comprises at least one of endothermic, char forming and ablative, insulative, flame retardant, or intumescent compounds, and combinations thereof.

### Embodiment 7

The use of any one of the preceding embodiments, wherein the non-porous structural sealant layer is selected from: an epoxy, a phenolic, urethane, acrylates, an imide, silicones, and combinations thereof.

### Embodiment 8

The use of embodiment 7, wherein the epoxy comprises a first part comprising a curable epoxy resin and a second part comprising at least two amino groups of formula —NR¹H where R¹ is selected from hydrogen, alkyl, aryl, or alkylaryl.

### Embodiment 9

The use of embodiment 8, wherein the curable epoxy resin comprises an epoxy phenol novolac.

### Embodiment 10

The use of any one of the preceding embodiments, wherein the non-porous structural sealant layer fixedly attaches to metal.

### Embodiment 11

The use of any one of the preceding embodiments, wherein the 2-layer firestop system cures within 1 week.

### Embodiment 12

A method of fire-stopping and sealing a substrate, the method comprising: providing a marine construction assembly comprising (i) a major surface, wherein the surface comprises a penetration which intersects the major surface, the major surface further comprising a first attachment area located about the perimeter of the penetration, and (ii) a penetrating object having a second attachment area, wherein the penetrating object passes through the penetration and extends beyond the major surface of the marine construction assembly; inserting a foam layer comprising at least one fire-stopping additive into the penetration; applying a non-porous structural sealant to the major surface contacting the first attachment area and the second attachment area to seal the penetration; and curing the non-porous structural sealant.

### Embodiment 13

The method of embodiment 12, wherein the structural sealant has an overlap shear strength of at least 250 psi (1.7 MPa).

### Embodiment 14

The method of any one of embodiments 12-13, further comprising cleaning the first and/or second attachment area prior to applying the structural sealant.

### Embodiment 15

The method of any one of embodiments 12-14, wherein the marine construction assembly is selected from a boat, a ship, a watercraft carrier, a bridge, or an oil rig.

### Embodiment 16

The method of any one of embodiments 12-15, wherein the non-porous structural sealant layer fixedly attaches to the first attachment area and the second attachment area.

### Embodiment 17

The method of any one of embodiments 12-16, wherein the foam layer comprises an open cell foam.

### Embodiment 18

The method of any one of embodiments 12-17, wherein the foam layer comprises at least one of: a polyurethane, silicone, and combinations thereof.

### Embodiment 19

The method of embodiment 18, wherein the polyurethane comprises a polyisocyanate.

### Embodiment 20

The method of any one of embodiments 12-19, wherein the at least one fire-stopping additive comprises at least one of endothermic, char forming and ablative, insulative, flame retardant, or intumescent compounds, and combinations thereof.

### Embodiment 21

The method of any one of embodiments 12-20, wherein the non-porous structural sealant layer is selected from: an epoxy, a phenolic, urethane, acrylates, an imide, silicones, and combinations thereof.

### Embodiment 22

The method of embodiment 21, wherein the epoxy comprises a first part comprising a curable epoxy resin and a second part comprising at least two amino groups of formula —NR¹H where R¹ is selected from hydrogen, alkyl, aryl, or alkylaryl.

### Embodiment 23

The method of embodiment 22, wherein the curable epoxy resin comprises an epoxy phenol novolac.

### Embodiment 24

A firestop assembly comprising: a foam layer comprising at least one fire-stopping additive; a non-porous structural sealant layer; and a marine construction assembly comprising a penetration.

### Embodiment 25

The firestop assembly of embodiment 24, wherein the structural sealant has an overlap shear strength of at least 250 psi (1.7 MPa).

### Embodiment 26

The firestop assembly of any one of embodiments 24-25, wherein the firestop assembly has a pressure rating of 4.5 bar for 30 min.

### Embodiment 27

The firestop assembly of any one of embodiments 24-26, wherein the firestop assembly has a water leakage on the structural sealant side that passes UL 1479-2015.

### Embodiment 28

The firestop assembly of any one of embodiments 24-27, wherein the firestop assembly passes IMO Resolution A754 “Fire Test Procedure Code MSC 88/26/Add.2 Appendix 2”.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods. These abbreviations are used in the application: cm=centimeter; dia.=diameter; in =inch; lb=pound; mm=millimeter; m=meter; psi=pound per square inch; psig=pounds per square inch gauge; MPa=megaPascal; and ft=foot.

Test Methods

Steel Bulkhead Construction

A class “A” bulkhead was built as described in section 2.1 of International Marine Organization APPENDIX 1: FIRE RESISTANCE TEST PROCEDURES FOR “A”, “B” AND “F” CLASS DIVISIONS of MSC 88/26/Add.2.

Pressure Vessel

A steel pressure vessel was used for the pressure testing. The dimensions of this cylindrical vessel was 3 ft (0.9 m) in diameter and 4 ft (1.2 m) in length. Four 8 in (2.4 m) diameter by 12 in (3.7 m) long flange were located on the top of the vessel along with one pressure intake valve. Three of the flanges were sealed with a piece of steel and the fourth flange (“testing flange”) was used for testing the polymeric materials.

Water Leakage Vessel

The Water Leakage Vessel comprised two 4 inch (10 cm) diameter polyvinyl chloride pipes. The top pipe was three feet in length. The bottom pipe was at least 4 inches (10 cm) long and comprised the testing materials. The two pipes were connected with a union and sealed together.

Pressure Test

The Pressure Vessel was attached to an air source, which generated a high pressure within the Pressure Vessel. Using house compressed air, the pressure in the Pressure Vessel was increased until 66 psi (4.49 bar) was reached and was held at 66 psi. To pass the test, there was no leakage through the testing flange at a minimum of 1.5 bar.

Fire Test

The Steel Bulkhead Construction was fire tested according to International Marine Organization, MSC 88/26/Add.2, 7 Feb. 2011. The sample was tested for a 60 minutes. In order to pass the F-rating or flaming test, there must be no occurrence of flaming on the “cold side” of the test assembly (i.e., side of the construction opposite of the fire). In order to pass the T-rating or temperature test, the thermocouple on the “cold side” of the test assembly must reach 400° F. greater than ambient temperature during the test.

Water Leakage Test

Water was colored with a dye. The Water Leakage Vessel was held vertical, with the bottom pipe (comprising the testing materials) on the bottom. A white indicating medium was placed immediately below the vertically-held Water Leakage Vessel. Colored water was added to the Water Leakage Vessel such that there was three feet of colored water on top of the coating (approximately 1.3 psig). After sitting for 72 hours, the indicating media and the underside of the Water Leakage Vessel were examined for the presence of water or dye. To pass the test there was no observed presence of water or dye.

Materials Table

| Material | Description |
|---|---|
| Foam | A 2-part fire stop polyurethane foam available under the trade designation “3M |
| | FIRE BARRIER FOAM FIP-1 STEP” from 3M Co., St. Paul, MN |
| Coating A | A 2 component, ambient cured, 100% solids, liquid epoxy available under the |
| | trade designation “3M SCOTCHKOTE ABRASION RESISTANT EPOXY |
| | COATING 328” from 3M Co. Reported tensile 5837 psi (40.2 MPa) via ASTM |
| | D2370. |
| Coating B | A one component, moisture curing hybrid sealant available under the trade |
| | designation “3M HYBRID ADHESIVE SEALANT 760” from 3M Co. |
| | Reported tensile 260 psi (1.8 MPa) via ASTM D412. |
| Coating C | A one component, silicone elastomer available under the trade designation “3M |
| | FIRE BARRIER SILICONE SEALANT 2000+” from 3M Co. Reported tensile |
| | 350 psi (2.4 MPa) via ASTM D412. |
| Coating D | A one component, latex-based elastomeric sealant available under the trade |
| | designation “3M FIRE BARRIER SEALANT FD 150+” from 3M Co. Reported |
| | tensile 85 psi (0.6 MPa) via ASTM D882. |
| Coating E | A two component epxoy available under the trade designation “3M |
| | SCOTCHCAST ELECTRICAL RESIN 5” from 3M Co. Reported tensile 8000 |
| | psi (55.2 MPa) via ASTM D882. |
| Coating F | A two component epxoy available under the trade designation “3M |
| | SCOTCHCAST ELECTRICAL RESIN 8” from 3M Co. Reported tensile 1700 |
| | psi (11.7 MPa) via Fed. Std. No. 406, method 1011. |
| Coating G | A two component mercaptan cured epoxy available under the trade designation |
| | “3M SCOTCH-WELD DP100 CLEAR” from 3M Co. Reported tensile 1850 psi |
| | (12.8 MPa) via Fed. Std. No. 406, method 1011. |
| T300 cable | A watertight, non-flexing service conductor cable with a crosslinked polyolefin |
| | jacket, overall maximum diameter of 1.957 in (about 5 cm) (LSTSGU-300 |
| | obtained from Seacoast Electric Co., Hawthorne, NY) via C-3094/ASTM D882. |

### EXAMPLES

### Examples 1-8 and Comparative Examples A-C(CE A-CE C)

In Examples 1-8 and CE B and CE C, Foam was placed into testing flange of the Pressure Vessel at a 4 in (10 cm) depth. CE A did not comprise a foam layer. After waiting approximately 1 hr for the foam to cure and cool, the material listed in Table 1 was applied onto the flange (above the foam) at the listed thickness. The coating material contacted the sides of the flange and the Foam, if present. After curing for 30 days, the flange was attached to the Pressure Vessel, with the structure sealant exposed to the pressure side and the Foam exposed to the atmospheric pressure side. The Pressure Vessel was attached to an air source, which generated a high pressure within the Pressure Vessel. The Pressure Vessel was then tested following the Pressure Test. Shown in Table 1 is the coating used, thickness of the coating, a penetrating object, if present, and whether or not the Example passed (i.e., no pressure leakage) at 1.5 bar, 3 bar and 4.5 bar. The results are shown in Table 1.

TABLE 1

| | | Coating | | | | |
|---|---|---|---|---|---|---|
| | | thickness | Penetrating | Pressure | | |
| Example | Coating | (in) | object | 1.5 bar | 3 bar | 4.5 bar |
| CE A | A | 0.25 | none | pass | pass | fail |
| CE B | none | 0 | none | fail | fail | fail |
| 1 | B | 0.5 | none | pass | fail | fail |
| 2 | C | 0.5 | none | pass | fail | fail |
| CE C | D | 0.5 | none | fail | fail | fail |
| 3 | E | 0.5 | none | pass | pass | fail |
| 4 | F | 0.5 | none | pass | fail | fail |
| 5 | G | 0.5 | none | pass | fail | fail |
| 6 | A | 0.06 | none | pass | fail | fail |
| 7 | A | 0.25 | none | pass | pass | pass |
| 8 | A | 0.25 | one T300 | pass | pass | pass |
| | | | cable | | | |

### Example 9

The Steel Bulkhead Construction was used as described. Twenty two T300 cables were used. The cables were cut into 3 ft (0.9 m) lengths and situated such that they penetrated though the middle of the transit. The transit was filled with 4 in (10 cm) depth of Foam, surrounding all cables and attached to the edges of the transit. After 1 hour, Coating A was applied to a thickness of 0.25 in and in contact with the edges of all power cables and the edges of the transit. The construction was tested according to the Fire Test. The Example passed both the F-rating and the T-rating.

### Examples 10-15 and Comparative Examples CE D and CE E

In Examples 10-15 and CE D and CE E, Foam was placed into the bottom pipe of the Water Leakage Vessel at a 4 in (10 cm) depth. After waiting approximately 1 hr for the foam to cure and cool, the designated coating material listed in Table 2 (if used) was applied into the bottom pipe above the foam to a thickness of 0.25 inches (6.4 mm). The coating material contacted the Foam and the sides of the PVC pipe. After curing for 30 days, the bottom pipe was attached to the top pipe (with the coating material facing the top pipe and the foam facing downward), and joined with a union to form the Water Leakage Vessel. The Water Leakage Vessel then was tested following the Water Leakage Test. The results are shown in Table 2.

TABLE 2

| Example | Coating | Water Leakage |
|---|---|---|
| CE D | none | fail |
| 10 | A | pass |
| 11 | B | pass |
| 12 | C | pass |
| CE E | D | fail |
| 13 | E | pass |
| 14 | F | pass |
| 15 | G | pass |

Foreseeable modifications and alterations of this invention will be apparent to those skilled in the art without departing from the scope and spirit of this invention. This invention should not be restricted to the embodiments that are set forth in this application for illustrative purposes.

1.-6. (canceled)

7. A method of fire-stopping and sealing a substrate, the method comprising
a. providing a marine construction assembly comprising (i) a major surface, wherein the surface comprises a penetration which intersects the major surface, the major surface further comprising a first attachment area located about the perimeter of the penetration, and (ii) a penetrating object having a second attachment area, wherein the penetrating object passes through the penetration and extends beyond the major surface of the marine construction assembly;
b. inserting a foam layer comprising at least one fire-stopping additive into the penetration;
c. applying a non-porous structural sealant to the major surface contacting the first attachment area and the second attachment area to seal the penetration; and
d. curing the non-porous structural sealant.

8. The method of claim 7, wherein the structural sealant has an overlap shear strength of at least 250 psi (1.7 MPa).

9. The method of claim 7, wherein the non-porous structural sealant layer fixedly attaches to the first attachment area and the second attachment area.

10. The method of claim 7, wherein the foam layer comprises an open cell foam.

11. The method of claim 7, wherein the foam layer comprises at least one of: a polyurethane, silicone, and combinations thereof.

12. The method of claim 7, wherein the at least one fire-stopping additive comprises at least one of endothermic, char forming and ablative, insulative, flame retardant, or intumescent compounds, and combinations thereof.

13. The method of claim 7, wherein the non-porous structural sealant layer is selected from: an epoxy, a phenolic, urethane, acrylates, an imide, silicones, and combinations thereof.

14. A firestop assembly comprising:
a. a foam layer comprising at least one fire-stopping additive;
b. a non-porous structural sealant layer; and
c. a marine construction assembly comprising a penetration.

15. The method of claim 7, further comprising cleaning the first and/or second attachment area prior to applying the structural sealant.

16. The method of claim 7, wherein the marine construction assembly is selected from a boat, a ship, a watercraft carrier, a bridge, or an oil rig.

17. The method of claim 11, wherein the polyurethane comprises a polyisocyanate.

18. The method of claim 7, wherein the epoxy comprises a first part comprising a curable epoxy resin and a second part comprising at least two amino groups of formula —NR¹H where R¹ is selected from hydrogen, alkyl, aryl, or alkylaryl.

19. The method of claim 7, wherein the curable epoxy resin comprises an epoxy phenol novolac.

20. The firestop assembly of claim 14, wherein the structural sealant has an overlap shear strength of at least 250 psi (1.7 MPa).

21. The firestop assembly of claim 14, wherein the foam layer comprises an open cell foam.

22. The firestop assembly of claim 14, wherein the foam layer comprises at least one of: a polyurethane, silicone, and combinations thereof.

23. The firestop assembly of claim 14, wherein the non-porous structural sealant layer is selected from: an epoxy, a phenolic, urethane, acrylates, an imide, silicones, and combinations thereof.

24. The firestop assembly of claim 23, wherein the epoxy comprises a first part comprising a curable epoxy resin and a second part comprising at least two amino groups of formula —NR¹H where R¹ is selected from hydrogen, alkyl, aryl, or alkylaryl.

25. The firestop assembly of claim 24, wherein the curable epoxy resin comprises an epoxy phenol novolac.

26. The firestop assembly of claim 14, wherein the at least one fire-stopping additive comprises at least one of endothermic, char forming and ablative, insulative, flame retardant, or intumescent compounds, and combinations thereof.
